(19) United States
(12) Patent Application Publication
(10) Pub. No.: US 2004/0060403 A1
(43) Pub. Date: Apr. 1, 2004

(54) One cut device

(75) Inventor: Timothy Pace, Houston, TX (US)

Correspondence Address: Keith R. Derrington, Keith R. Derrington, P.C., Suite 465, 10260 Westheimer, Houston, TX, 77042, US

(73) Assignee: PACE PRECISION

(21) Appl. No.: 10/669,936

(22) Filed: Sep. 24, 2003

Related U.S. Application Data
(60) Provisional application No. 60/413,306, filed on Sep. 25, 2002.

(51) Int. Cl. B23B 25/00

(52) U.S. Cl. 82/162

(57) ABSTRACT

Disclosed herein is a workpiece holder for use with a rotatable lathe assembly. The workpiece holder comprises a housing with a base and two upwardly projecting outer sides. The first section is adapted to receive a workpiece to be machined and support the workpiece during the machining process. The support provided by the first section minimizes deflection of the workpiece and enhances the machining process.

### RELATED APPLICATIONS

This application claims priority from co-pending U.S. Provisional Application No. 60/413,306 filed Sep. 25, 2002, the full disclosure of which is hereby incorporated by reference herein.

### BACKGROUND OF THE INVENTION

1. Field of the Invention

The invention relates generally to the field of holders for machinable workpieces. More specifically, the present invention relates to an apparatus for holding workpieces during machining. Yet more specifically, the present invention relates to a device for holding and supporting a workpiece while providing a location to machine the workpiece proximate to the location where the workpiece is being supported.

2. Description of Related Art

Lathe assemblies of the simplified type shown in FIG. 1 have long been used in conjunction with the machining of workpieces. Typically the workpieces are initially mass produced in a few standard diameters, but will need to be machined to a smaller diameter when implemented for a specific application. The machining process generally involves securing a workpiece 9 to a lathe assembly 5 by clamping the workpiece 9 within a chuck 7. Rotation of the chuck 7 is then activated thereby producing rotation of the workpiece 9. A cutting element 13 is then applied to the unsecured end of the workpiece 9 to cut away a portion of the workpiece 9 and machine it to the desired size and/or shape. Unfortunately, the application of the cutting element against 13 the workpiece 9 often produces a sufficient moment arm to deflect the workpiece 9. Since machining workpieces of this nature require tolerances accurate to less than 1/1000 of an inch, such a deflection can produce less than satisfactory results with regard to the final dimensions of the machined workpiece 9. This results in the need to make multiple machining passes in order to produce a workpiece 9 having dimensions within the specified design tolerance. These multiple passes are time consuming and costly.

Therefore, there exists a need for an apparatus and a method for machining workpieces that results in a machined workpiece that is at the specified dimension and within tolerance. Furthermore, there exists a need for an apparatus and method of machining workpieces where the workpiece can be machined to within tolerance with a single pass of a cutting element across the workpiece.

### BRIEF SUMMARY OF THE INVENTION

The present invention involves a workpiece holder for use with a lathe assembly. The workpiece holder comprises a base mountable on the carriage of a lathe, and at least one flange attached to and extending upwardly from the base. The flange has a workpiece support opening formed through its face, where the opening is sized for free longitudinal movement of the workpiece through the opening. The size of the opening should also be sized to prevent lateral movement of the workpiece beyond a predetermined tolerance.

A bushing assembly can be included with the present invention that is insertable into the workpiece support opening. The bushing assembly is adaptable to receive a workpiece of varying size. The workpiece holder of the present invention further comprises at least one bearing assembly insertable into the workpiece support opening. Preferably the workpiece support opening is perpendicularly disposed within the workpiece holder. The workpiece holder of the present invention can further include a second vertical flange, where a channel is disposed between the first flange and the second flange. A passage is perpendicularly formed in the second flange that is substantially coaxial with the workpiece support opening. The passage is capable of supporting a machined portion of the workpiece. A supporting sleeve is optionally included that is securable to the second flange.

The workpiece holder of the present invention can further include a carriage included with the lathe assembly on which the workpiece holder can be secured. The carriage should be capable of moving along the length of the lathe assembly thereby moving the workpiece holder along the length of the lathe assembly.

The present invention includes a method of machining a workpiece comprising securing one end of a workpiece in a lathe assembly, supporting the unsecured portion of the workpiece within a workpiece holder at some discrete position along the length of the workpiece, and machining the workpiece with a cutting element, where the cutting element is connectable to the workpiece holder at a location proximate to the position where the workpiece is supported by said workpiece holder. The method can also include moving the workpiece holder and cutting element together in a direction that is substantially parallel to the axis of the workpiece and together toward the secured end of the workpiece. The method of the present invention can also include the flexibility of varying the location of the cutting element with respect to the axis of the workpiece during the machining process.

### BRIEF DESCRIPTION OF THE SEVERAL VIEWS OF THE DRAWING

FIG. 1 illustrates a prior art device.

FIG. 2 depicts a side view of one embodiment of the invention.

FIG. 3 illustrates a frontal view of one embodiment of the present invention.

FIG. 4 provides a side view of one embodiment of the invention combined with a lathe assembly.

FIG. 5 provides a partial cutaway view of one embodiment of a bearing assembly.

FIG. 6 provides a perspective view of one embodiment of a bushing.

FIG. 7 provides a partial cutaway view of the present invention combined with a support sleeve.

FIG. 8 provides a perspective view of one embodiment of the present invention.

FIG. 9 provides a perspective view of an additional embodiment of the present invention.

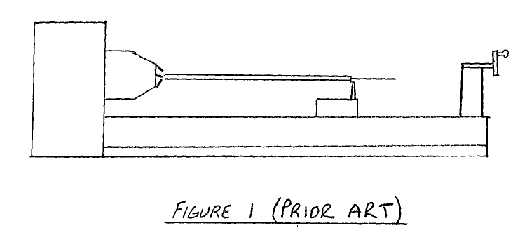

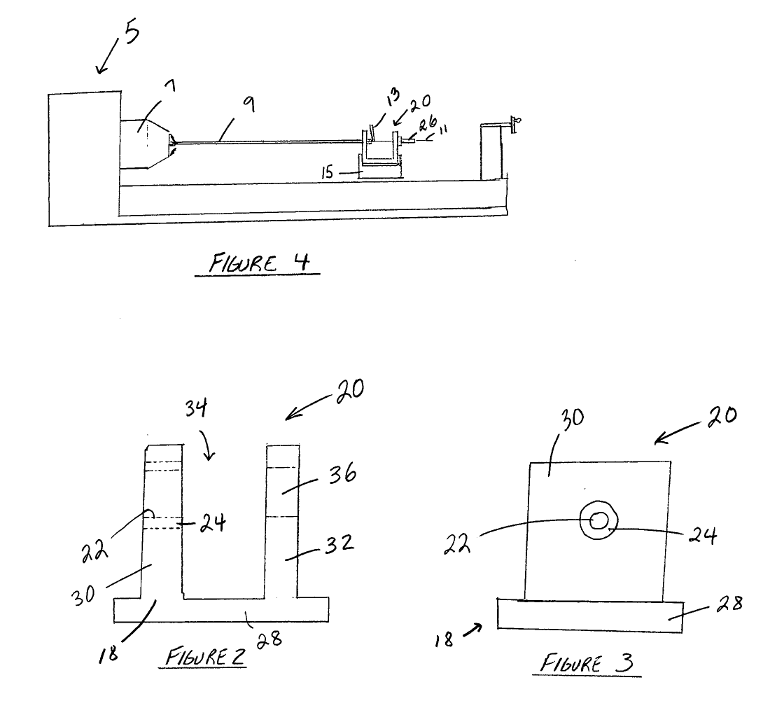

### DETAILED DESCRIPTION OF THE INVENTION

With reference to the drawings herein, one embodiment of the present invention is shown in side view in FIG. 2. The workpiece holder 20 of FIG. 2 of an embodiment of the present invention comprises a base 28 with a pair of attached, upwardly projecting spaced flanges 30 and 32. The base 28 has a substantially rectangular face and cross section and provides a support on which to secure the first flange 30 and the second flange 32 The first flange 30 has a first face 31 while the second flange 32 has a second face 33, faces 31 and 33 being generally parallel to one another. As shown the first section 30 has a generally rectangular face and cross section.

First and second sections flanges 30 and 32 form a channel 34 therebetween. The channel 34 is bounded on its bottom by the base 28. The channel 34 is open at its top and its respective ends. The dimensions of the channel 34 should be sized to accommodate the cutting devices used in machining workpieces, such as a profiling tool.

An aperture 22 is formed through the face 31 of the first flange 30. Preferably a bearing assembly 24 is provided within the aperture 22. As shown in FIG. 5, one embodiment of the bearing assembly 24 includes a series of bearings 40 confined between a circular inner race 39 and a circular outer race 38. The bearings 40 are preferably cylindrical roller bearings, but can also be ball bearings or needle bearings. The bearing assembly 24 is not limited to the type of bearings listed, but can include any device capable of reducing resistance to rotational movement. Further, the thickness of the bearing assembly 24 can match, exceed, or be less than the length of the aperture 22. It is preferred that the bearing assembly 24 be retained within the aperture 22 with a retaining or snap ring (not shown). Alternatively, the bearing assembly 24 can be press fitted within the aperture 22.

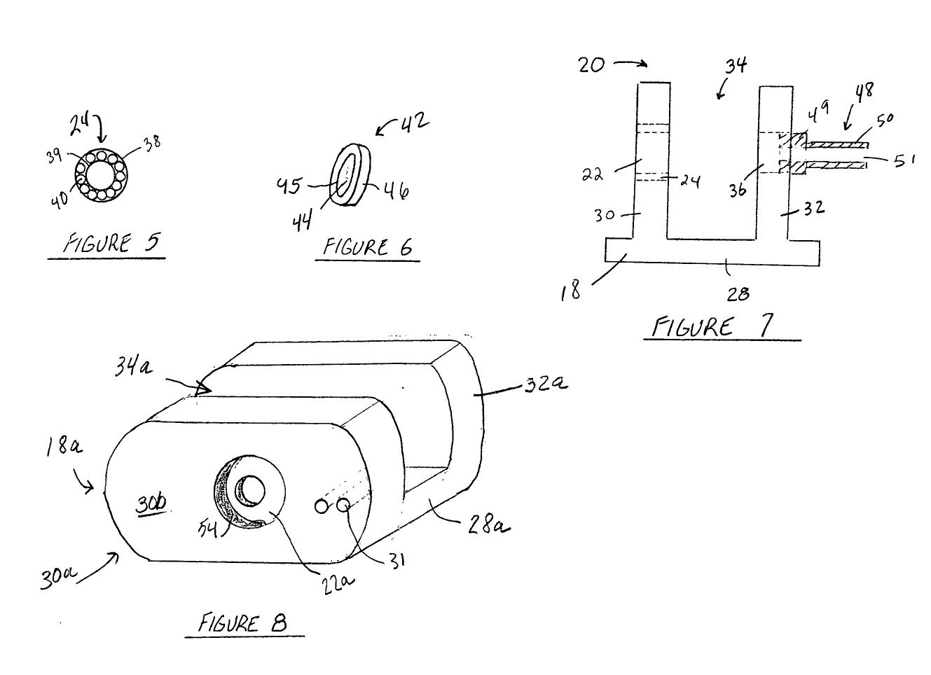

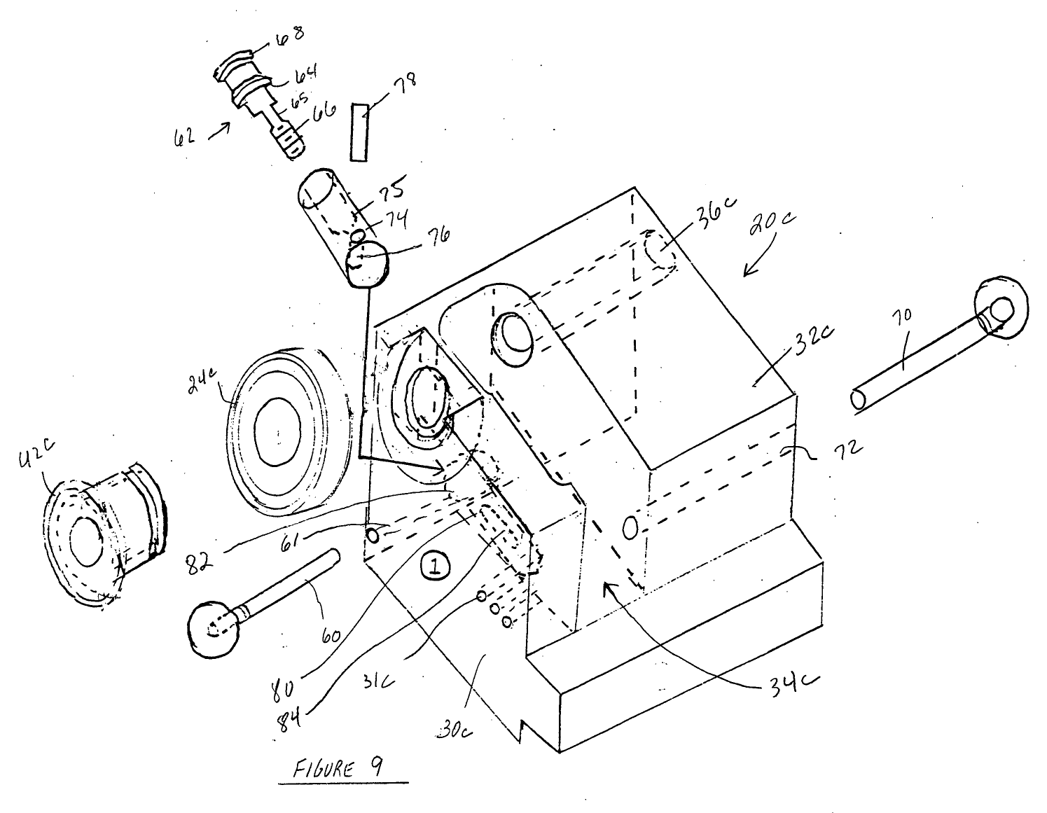

Preferably the bearing assembly 24 should be capable of receiving a bushing 42 within its inner circumference. The bushing 42 as shown in FIG. 6 is a disklike structure with an opening 44 formed in its center along its axis. The bushing 42 is preferably press fitted within the bearing assembly 24. As will be discussed in more detail below, the configuration of the bushing 42 considered can vary, more specifically the inner circumference 44 can change in magnitude, while the outer diameter 46 should remain constant. Additionally, the length of the bushing 42 can change depending on the particular application of the bushing 42.

The second flange 32 has generally the same configuration and dimensions as the first section 30. A passage 36 is formed through the second flange 32 that is coaxial with the aperture 22 in the first flange 30. Optionally a sleeve support 48 can be included on the second section 32 coaxial with the passage 36. The sleeve support 48 includes a base section 49 that is securable within the passage 36 on the side of the second section 32 opposite the first section 30. A sleeve 50 is disposed on the base section 49 that extends away from the outer face of the second section 32. Formed through the sleeve support 48 is a sleeve opening 51 that extends along the axis of the sleeve support 48. Preferably the sleeve support 48 is securable to the passage 36 by industrial fasteners such as screws or bolts, however other manners of attachment such as press fit, welding, a threaded connection, or other known means can be employed as well.

FIG. 8 depicts an alternative embodiment of the holder of the present invention having first and second flanges (30a and 32a). As shown in FIG. 8, the first flange 30a and the second flange 32a have a substantially rectangular cross section and are oval shaped when viewed from the front and rear. Optionally formed through the first flange 30a is at least one slot 31 that can be internally threaded in which a screw (not shown) can be inserted to urge and retain a cutting element against the inner surface of the second flange 32a during the machining process. In the embodiment of FIG. 8, the base 28a has a substantially rectangular cross section and face. The housing 18a can be constructed by being machined from a single piece of stock material, alternatively the component parts can be individually constructed and connected by means such as industrial fasteners, welding, and any other now known or later developed fabrication technique.

The aperture 22a formed through the first flange 30a includes a counterbore 54 disposed on the front face 30b of the first flange 30a. The dimensions of the counterbore 54 can vary depending on the size of the bearing assembly 24 utilized. It is preferred that the inner circumference of the counterbore 54 be slightly less than the outer circumference of the bearing assembly 24 to facilitate a tight and secure press fit of the bearing assembly 24 within the counterbore 54. It is further preferred that the depth of the counterbore 54 closely match the thickness of the bearing assembly 24 to prevent the bearing assembly 24 from jutting out past the front face 30b of the first flange 30a. It is believed that the dimensions of the counterbore 54 and associated bearing assembly 24 can be readily determined by those skilled in the art without undue experimentation.

Another alternative embodiment of the present invention is presented in FIG. 9. Here the workpiece holder 20c includes a rectangular first flange 30c separated by a channel 34c from a second flange 32c. The width of the second flange 32c of this embodiment exceeds the width of the first flange 30c. Also included with this embodiment are threaded slots 30c for screws to impinge a cutting element (not shown) on the inside face of the second flange 32c and a retaining pin 70 for adjusting the cutting element. The embodiment of FIG. 9 also includes a way of adjusting the position of the cutting element with respect to the radius of the workpiece 9. A bored out portion 80 having a counterbore 82 proximate to the opening is provided on the rear side of the workpiece holder 20. The bored out portion 80 is formed to receive an adjustment sleeve 74. An adjustment sleeve pin 78 is insertable into an adjustment sleeve slot 76 formed on the top side of the adjustment sleeve 74. The adjustment sleeve pin 78 is to be inserted into the adjustment sleeve slot 76 through an axial groove 84 that runs along the axis of the bored out portion 80 thereby providing an opening between the bored out portion 80 and the channel 34c. Thus when the adjustment sleeve pin 78 is inserted into the adjustment sleeve slot 76, its top portion will extend up into the channel 34c.

An adjustment screw 62 is provided that is adapted for insertion into the adjustment sleeve 74. The adjustment screw 62 includes screw threads 66, a screw shoulder 64 that extends radially outward from the surrounding portion of the adjustment screw, and a screw saddle 65 disposed between the screw shoulder 65 and the screw threads. The adjustment screw 62 should be inserted into the adjustment sleeve 74 after the adjustment sleeve 74 is within the bored out portion 80. Threads 75 are provided within the adjustment sleeve 74 that mate with the screw threads 66 thereby enabling the adjustment screw 62 to be screwed into the adjustment sleeve 74. Once the combination of the adjustment screw 62 and the adjustment sleeve 74 is inserted within the workpiece holder 20c, an anchor pin 60 can be inserted into an anchor slot 61. The anchor pin 60 is formed to fit adjacent the screw saddle 65. Since the portion of the adjustment screw 62 having the threads has a diameter greater than that of the screw saddle 65, the adjustment screw 62 is prevented from being retracted from within the workpiece holder 20c by the presence of the anchor pin 60. Further the increased diameter of the screw shoulder 64 mates with the inner section of the counterbore 82 that prevents the adjustment screw 62 from being pushed further into the bored out portion 80. As such, the combination of the anchor pin 60 and the counterbore 82 maintain the adjustment screw 62 in relatively the same position within the bored out portion 80. However the adjustment screw 62 can be rotated by twisting the screw head 68, this rotation through the interaction of the screw threads 66 and the threads within the adjustment sleeve 74 is capable of producing movement of the adjustment sleeve 74 along the axis of the adjustment screw 62. This in turn causes lateral movement of the adjustment sleeve pin 78 within the channel 34c. The adjustment sleeve pin 78 is further capable of receiving a cutting element on its upper end. Accordingly, the position and alignment of a cutting element within the channel 34c can be adjusted by rotating the screw head 68.

In operation, as illustrated in FIG. 4, the workpiece holder 20 of the present invention is combined with a lathe assembly 5 by connecting the workpiece holder 20 to a carriage 15. A properly sized bushing 42 that matches the outer circumference of the particular workpiece 9 being machined should be installed in the aperture 22 of the workpiece holder 20. Preferably the inner diameter of the bushing 42 should be within 1/2000 of an inch to about 1/1000 of an inch, thus the aperture 22 provides a support opening for the workpiece 9. One of the many advantages of the present invention is its ability to be used on most lathes with only minor adjustments to the lathe. A workpiece 9, comprised of an elongated material is secured into the chuck 7 of the lathe assembly 5. At this time the axis of the workpiece 9 should be aligned with the axis of the aperture 22. Further, at this time the cutting element 13 should be positioned at the proper location for machining the workpiece 9.

After set up of the lathe assembly 5 and workpiece holder 20 is complete, the carriage 15 with the attached workpiece holder 20 is then positioned to place the workpiece 9 within the aperture 22. For the purposes of illustration the carriage 15 is shown in FIG. 4 as a single item, however it can be comprised of more than one component. For example, in one embodiment of the present invention the carriage can be comprised of a well-known tool post on which the workpiece holder 20 is anchored. In turn the tool post can be secured to what is known in the art as a compound. The combination of the tool post and the compound provide the flexibility of adjusting the workpiece holder 20 in a vertical direction as well as a lateral direction. A suitable tool post can be purchased from Aloris Tool Technology Co. Inc., 397-407 Getty Ave, P.O. Box 1529, Clifton, N.J.; a suitable compound can be purchased from Hardinge of Elmira N.Y. It is well within the capabilities of those skilled in the art to assemble the required components of the lathe assembly 5, secure the workpiece holder 20 to the carriage 15 such that the axis of the workpiece 9 is aligned with the aperture 22, and position the cutting element 13 in the proper location for machining of the workpiece 9.

Rotation of the workpiece 9 is initiated by activation of the lathe assembly 5. Further urging of the workpiece 9 into the workpiece holder 20 results in contact of the rotating workpiece 9 with the cutting element 13. Once inside of the aperture 22, the workpiece 9 is engaged within the bushing 42. As noted above, the inner diameter of the bushing 42 closely matches the outer diameter of the workpiece 9, thereby minimizing movement of the workpiece 9 perpendicular to its axis while allowing free movement of the workpiece 9 along its axis. As machining of the workpiece 9 begins, the cutting element 13 applies a tangential force onto the workpiece 9. However the deflection of the workpiece 9 is kept at a negligible amount by the support provided by the combination of a bearing assembly 24 and a bushing 42. By negating workpiece 9 deflection during the machining process, it is possible to produce a final product on a single machine pass having dimensions that are well within the anticipated and design tolerances. Furthermore, another advantage of the present invention is its capability to machine the workpiece 9 to a wide variety of diameters along the length of the workpiece 9.

As the machining process proceeds, the carriage 15 slowly moves towards the chuck 7 thereby ultimately allowing the cutting element 13 to machine the length of the workpiece 9. Continued movement of the carriage 15 and attached workpiece holder 20 toward the chuck 7 urges the unsecured end of the workpiece 9 (and now machined portion) through the passage 36 and the sleeve opening 51. Thus an additional advantage of the present invention is the supporting function provided by the sleeve support 48 in maintaining the machined portion of the workpiece 9 in a generally horizontal orientation. In addition to the ability to machine a workpiece 9 to a precise dimension all along its length, other advantages of the present invention include the ability to remove the taper along a machined workpiece 9. Further, the present invention can be combined with older lathe assemblies having worn parts that are no longer able to accurately machine workpieces, and when combined with the worn lathe assemblies, can be used to produce precisely machined workpieces 9 all along their lengths and without taper.

The capability of implementing a bushing 42 of varying sizes enables the user to operate on workpieces of unlimited sizes. Additionally, the advantages of the present invention provide the ability to machine numerous types of materials and still obtain the same optimal results. For example, workpieces comprised of any type of machinable metal, including but not limited to tungsten, steel, iron, and aluminum, can be successfully machined with the present invention. Furthermore, elastomeric materials, such as plastics, rubber, and TEFLON® can also be successfully machined with the present invention.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. For example, the thickness of the first flange 30 can greatly exceed the thickness of the second flange 32. In yet another alternative, the present invention includes an embodiment having a single upwardly extending flange having the workpiece support holder within the single flange. These and other similar modifications will readily suggest themselves to those skilled in the art, and are intended to be encompassed within the spirit of the present invention disclosed herein and the scope of the appended claims.

What is claimed is:

1. A workpiece holder for use with a lathe assembly comprising:
a base mountable on the carriage of a lathe, and
at least one flange attached to and extending upwardly from said base, said flange having a workpiece support opening therethrough, said opening being sized for free longitudinal movement of said workpiece through said opening while preventing lateral movement of
said workpiece beyond a predetermined tolerance.

2. The workpiece holder of claim 1 further comprising a bushing assembly insertable into said workpiece support opening.

3. The workpiece holder of claim 2, wherein said bushing assembly is adapted to receive a workpiece of varying size.

4. The workpiece holder of claim 1 further comprising at least one bearing assembly insertable into said workpiece support opening.

5. The workpiece holder of claim 4 further comprising a bushing assembly insertable into said bearing assembly.

6. The workpiece holder of claim 5 wherein said bushing assembly is adapted to receive a workpiece of varying size.

7. The workpiece holder of claim 1 wherein said workpiece holder is traversable along at least a portion of the length of the workpiece.

8. The workpiece holder of claim 1 wherein said workpiece support opening is perpendicularly disposed within said at least one flange.

9. The workpiece holder of claim 8 wherein said housing comprises a second flange, wherein said channel is disposed between said at least one flange and said second flange.

10. The workpiece holder of claim 9 further comprising a passage perpendicularly formed in said second flange, said passage being substantially coaxial with said workpiece support opening.

11. The workpiece holder of claim 10 wherein said passage is capable of supporting a machined portion of the workpiece.

12. The workpiece holder of claim 9 further comprising a supporting sleeve securable to said second flange.

13. The workpiece holder of claim 1 further comprising a carriage included with the lathe assembly capable of moving along the length of the lathe assembly wherein said workpiece holder is securable to the carriage.

14. A method of machining a workpiece comprising:
(a) securing one end of a workpiece in a lathe assembly;
(b) supporting the unsecured portion of the workpiece within a workpiece holder at some discrete position along the length of the workpiece; and
(c) machining the workpiece with a cutting element that is connectable to the workpiece holder at a location proximate to the position where the workpiece is supported by said workpiece holder.

15. The method of claim 14 further comprising moving said workpiece holder and cutting element together in a direction that is substantially parallel to the axis of the workpiece.

16. The method of claim 15 further comprising moving said workpiece holder and cutting element together toward the secured end of the workpiece.

17. The method of claim 14 further comprising varying the location of the cutting element with respect to the axis of the workpiece during the machining process.
